(19) United States
(12) Patent Application Publication
(10) Pub. No.: US 2002/0055911 A1
(43) Pub. Date: May 9, 2002

(54) System and method for controlling online purchases using an online account

(75) Inventor: Carl N. Guerreri, Manassas, VA (US)

Correspondence Address: PILLSBURY WINTHROP LLP, 1600 TYSONS BOULEVARD, MCLEAN, VA, 22102, US

(73) Assignee: Electronic Warfare Associates, Herndon, VA

(21) Appl. No.: 09/985,891

(22) Filed: Nov. 6, 2001

Related U.S. Application Data
(60) Provisional application No. 60/245,583, filed on Nov. 6, 2000.

(51) Int. Cl. G06F 17/60

(52) U.S. Cl. 705/64

(57) ABSTRACT

A system and method is disclosed for controlling online purchases using an online account. A buyer (e.g., a parent) initializes a prepaid card and online account for a shopper (e.g., a child) online at a clearinghouse server computer located on the Internet. The buyer sets up an account balance for the online account, using the buyer's credit card or bank account. Internet access restrictions are preset by virtual of the theme of the card purchased or programmed by the buyer and the clearinghouse server computer into the online account. The access restrictions are set by using at least one of a theme list, a theme list CD, a customized website list, and an access code. A shopper then receives the prepaid card from the buyer in the form of a gift certificate or equivalent for spending on the Internet, but the shopper may access only the websites allowed by the account and set by the buyer. The Internet websites requested by a shopper are accessed through the clearinghouse server computer or directly with the theme list CD, which approves or disapproves access to the requested Internet website. If the shopper is granted access to the requested Internet website, the shopper may purchase items at the website, and the clearinghouse server computer tracks the account balance of the online account. The clearinghouse server computer optionally may debit the buyer's credit card or bank account if set up by the buyer. Thus, a real world control of access is given to buyers (e.g., parents) over shoppers (e.g., children) that may access undesired Internet websites that sell goods to the shoppers but are paid for by the buyers.

This application is based on and claims priority from U.S. Provisional Application No. 60/245,583 filed Nov. 6, 2000.

### BACKGROUND

1. Field of the Invention

The present invention relates generally to online shopping via the Internet. More specifically, it relates to a system and method allowing a shopper to set up an online account.

2. General Background and Related Art

Transactions over a network typically comprise the steps of receiving data from merchants and linking account holders and merchants to a single financial account for processing the transactions. Once the financial accounts are identified, communication may occur between account holders and merchants regarding transactions.

Network-based sales systems have buyer computers, merchant computers, and payment computers for operation by a user desiring to buy online products. A buyer computer is programmed to receive a user request to purchase a product and cause a payment message to be sent to a payment computer. The payment computer is programmed to receive a payment message and cause an access message to be sent to a merchant computer. The merchant computer is programmed to receive, verify, and process the access message and cause a product to be sent to the user desiring to buy the product.

Further known in the art are charging methods for interactive on-line Internet services. The Internet services are provided from one or more servers to multiple terminals via the Internet, and the fees for such services are collected from the users. The methods include opening, in a server, an imaginary account with a limited dollar amount for a user, and withdrawing from the imaginary account the fees for the service provided to the user. The server provides predetermined services to the user within a range of the limited dollar amount preset in the imaginary account. Before withdrawing a fee from the imaginary account, the server can restrict services provided to the user terminals.

### SUMMARY

A method and system is disclosed for initializing an online account at a clearinghouse server computer for shopping on a network. The method and system sets an account balance and access restrictions to network sites for the online account. Access to a site is requested, approved or disapproved, and controlled, and items are purchased from the requested site if requested access to the site is approved.

### BRIEF DESCRIPTION OF THE DRAWINGS

The accompanying drawings that incorporate and constitute a part of the specification, illustrate embodiments of the invention, and, together with the description, explain the invention. In the drawings:

FIG. 1 illustrates a first exemplary computer network on which the present invention may be implemented.

FIG. 2 illustrates a second exemplary computer network on which the present invention may be implemented.

FIG. 3 is a flow chart illustrating a method of initializing an online account according to the present invention.

FIGS. 4A and 4B illustrate different applications used in the present invention.

FIG. 5 is a flow chart that illustrates the method of access by shoppers to commercial websites according to the present invention.

### DETAILED DESCRIPTION

The following detailed description refers to the accompanying drawings that illustrate the embodiments of the present invention. Other embodiments are possible and modifications may be made to the embodiments without departing from the spirit and scope of the invention. Therefore, the following detailed description is not meant to limit the invention. Rather the scope of the invention is defined by the appended claims.

The present invention is a system and method that allows a buyer to set up a prepaid online account having a specified balance for spending by a shopper on the Internet. Multiple buyers for multiple shoppers can use the system and method for purchasing multiple online accounts, but for the purposes of illustration of the present invention, a single buyer and shopper combination is used. Programming the online account to pay only for goods or services at approved Internet websites controls the spending of a shopper. Using the present system and method, a buyer can give a gift certificate to a shopper for spending on the Internet in the form of, for example, a prepaid card tied to an online account, and the buyer is assured the gift certificate will not be spent on any items not approved by the buyer. For example, a parent can give a child an online gift certificate and know the child cannot spend the gift certificate at undesirable websites.

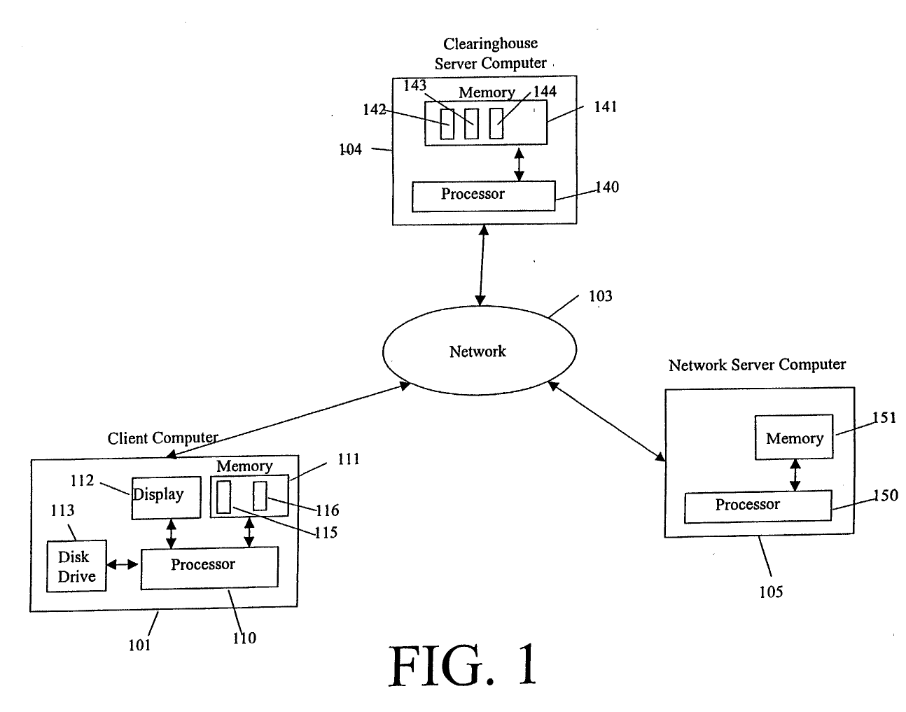

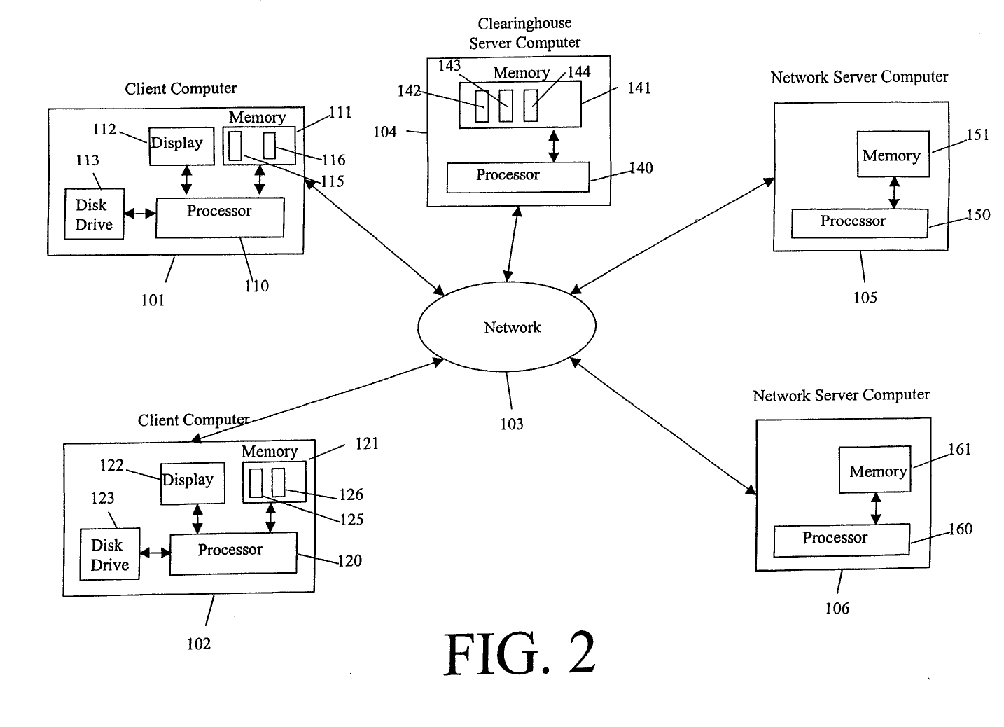

The present invention is usable with Internet browsers such as Netscape® or Microsoft Internet Explorer® and controls access of shoppers by buyers to Internet websites. FIG. 1 illustrates an exemplary computer network on which the present invention may be implemented. The computer network includes a client computer 101, a clearinghouse server computer 104, and a network server computer 105, but may include additional client or server computers as necessary or as known in the art as shown in FIG. 2. Client computer 101, clearinghouse server computer 104, and network server computer 105 are each connected to computer network 103. Network 103 may be, for example, the Internet but may also include other similar computer communication devices known in the art.

As shown, client computer 101 includes a processor 110 operatively coupled to a computer memory 111, a display 112, and a disk drive 113. Processor 110 executes program instructions stored in computer memory 111, such as from Internet browser 115 or e-mail program 116, or instructions loaded in disk drive 113 via a floppy disk or compact disk (CD). Information intended for the computer user may be displayed by processor 110 on display 112. As shown in FIG. 2, client computer 102 similarly includes a processor 120 operatively coupled to a computer memory 121, a display 122, and a disk drive 123. As with memory 111 of client computer 101, memory 121 of client computer 102 may also include an Internet browser 125 and an e-mail program 126, and disk drive 123 may also load floppy disks or CDs.

Client computers 101 and 102 may accept program instructions from network 103 or from a computer storage device, such as memories 111 and 121 that may be optical or magnetic disks. BIOS code (i.e., computer instructions), causing the system and method to implement the disclosed techniques, also may be programmed into a non-volatile portion of computer memories 111 and 121. The BIOS code may be programmed when the system is manufactured or when it is later delivered to a customer via a computer readable medium.

Client computers 101 and 102 can be any of a number of well-known computer systems, such as a personal computer (PC) based on processors from Intel® Corporation, of Santa Clara, Calif., or a Macintosh® computer based on processors from Motorola®, Inc., of Schaumburg, Ill. More generally, client computers 101 and 102 may be any type of computing platform known in the art connected to a network that interacts with application programs, such as a personal digital assistant or a “smart” cellular web telephone or pager.

Clearinghouse server computer 104, shown in FIGS. 1-2, can be any one of a number of well-known server computer systems. Clearinghouse server computer 104 includes a data storage device, such as memory 141, for storing data transferred from client computers 101 and 102 and network server computers 105 and 106. Memory 141 stores account information 142, account instructions 143, and a web server program 144 that communicates with Internet browsers 115 and 125 of client computers 101 and 102 and network server computers 105 and 106. The account information 142 contains online account IDs, customer names and balances, and the account instructions 143 contain information pertaining to the accessibility of Internet websites at network server computers 105 and 106. Specifically, clearinghouse server computer 104 includes a processor 140 for executing programs stored in memory 141 and for communicating with computers on the Internet, such as at network server computers 105 and 106, to control access to Internet websites from client computers 101 and 101.

Before a shopper desires to use an account balance of, for example, a prepaid card, the shopper must log into the clearinghouse server computer 104 from a client computer, such as client computer 101 or 102. Once logged into the clearinghouse computer 104 from client computer 101 or 102, the shopper may access websites on the Internet, at computers such as network server computers 105 and 106, through clearinghouse computer 104 from Internet browsers 115 or 125.

Network server computers 105 and 106 can also be any one of a number of well-known server computer systems or a network of server computer systems. Network server computers 105 and 106, respectively, include a data storage device, such as memories 151 and 161, for storing data transferred from clearinghouse server computer 104, and a processor 150 and 160 for executing programs that communicate with clearinghouse server computer 104. For example, network server computers 105 and 106 implement business to consumer websites that interact with clearinghouse server computer 104 to allow online shopping from client computers 101 and 102.

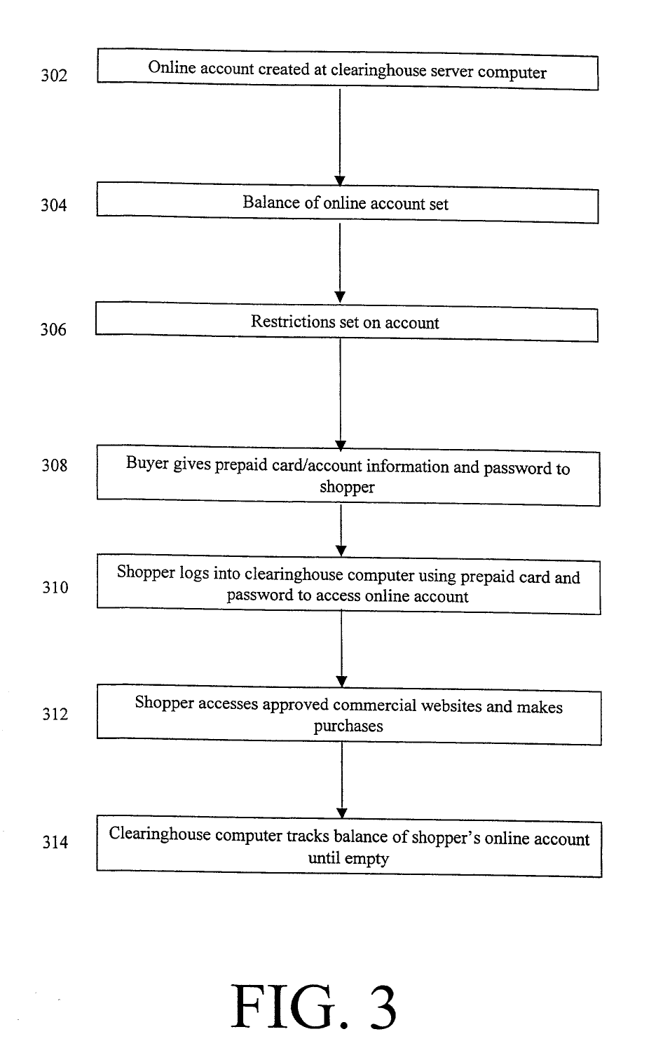

FIG. 3 is a flow chart illustrating a method of initializing an online account according to the present invention. First, an online account is created at clearinghouse server computer 104 (302). Any number of different models maybe employed to access the online account. The manner in which the online account is created will depend on the model. For example, in a first model, prepaid cards can be sold in a state ready to use. In this model, each prepaid card has a preset value and has a predetermined list of websites which can be accessed using the card as will be described in more detail below. An online account can be created for each prepaid card as each card is released for sale. Alternatively, either the organization or store selling the card or the purchaser of the card may be required to contact the clearinghouse server computer in order to create an account associated with the prepaid card.

In a second model, a prepaid card is also purchased. The card may have a predetermined value associated with it or may have a variable value. If the value of the card is variable, then the organization or store selling the card must access the clearinghouse server computer to establish the value. In the second model, the buyer of the card cannot employ the card immediately. Instead, the buyer must access the clearinghouse server computer in order to specify which websites can be accessed by the card, as will be described in more detail below.

In a third model, prepaid cards are not employed at all. Instead, a buyer simply contacts the clearinghouse server computer and requests an online account. At the same time, a buyer determines which websites can be accessed with the account.

Of course, the three models above are mere examples. Any combination of the three models and many other alternatives well known in the art are equally possible.

As noted above, the balance of the online account must be set (304). With the first model described above, the prepaid card has a preset value associated with it which establishes the balance of the online account. With the second model, the value on the prepaid card may be variable. As noted above, the organization or store selling the prepaid card must access the clearinghouse server computer to set the balance of the online account in accordance with the amount paid by the buyer of the card. With the third model in which there is no prepaid card, a buyer can establish any desired balance for the online account. The prepaid cards can be purchased or the online account balance set using either a credit card or an electronic funds transfer from the buyers bank account. In addition, the card or account optionally may be linked to the buyer's bank account to make payments against electronic invoices from Internet purchases received by the clearinghouse computer 104.

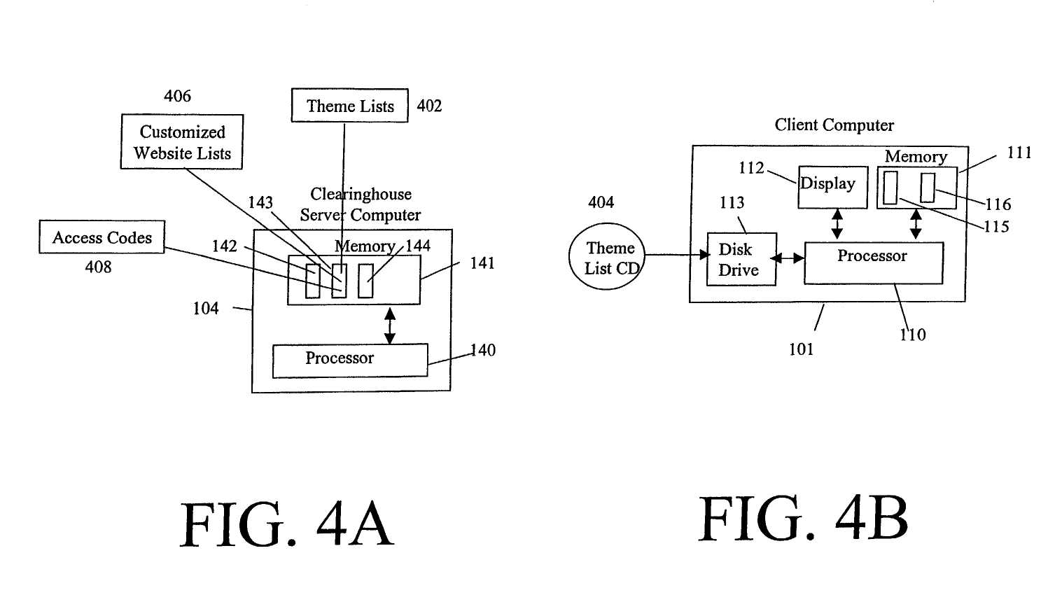

Once the online account is created, it is also necessary to specify any website access restrictions on the account (306). With the first model described above, the access restrictions are pre-set. Thus, prepaid cards would be sold with particular themes. For example, a children's prepaid card can be sold which limits access to only those websites appropriate for children. With the second model, the buyer of the prepaid card must access the clearinghouse server computer to specify any website access restrictions. Similarly, with the third model, as a buyer is creating an online account, the buyer would specify any website access restrictions. Of course, with either the second or third model, the buyer may specifiy that there should be no restrictions on website access. With the second or third model, the restrictions maybe specified in terms of a buyer-defined website list, a theme list, a third list CD, an access code or combination of any of these. The customized buyer-defined website lists, theme lists, theme list CDs, and access codes are defined with reference to FIGS. 4A and 4B and will be described in detail below.

After the online account is initialized, the buyer then gives the prepaid card or account information and password to a shopper (308). The shopper, using either client computer 101 or 102 and the prepaid card/account and password, then logs into the clearinghouse server computer 104 via the clearinghouse computer's website to access the online account (310). Once the shopper is logged into the clearinghouse computer 104, the shopper may access approved commercial websites and make purchases (312) through the clearinghouse computer 104, which maintains the confidentiality of the shopper's identity when the shopper accesses approved Internet websites.

As the shopper makes purchases on the Internet, the clearinghouse server computer 104 tracks the balance of the shopper's online account until it is empty (314). Alternatively, the clearinghouse computer 104 may make deposits to the shopper's online account via the buyer's credit card or bank account attached to the online account if set up by the buyer.

FIGS. 4A and 4B illustrate different applications used in the present invention. The clearinghouse server computer 104 in FIG. 4A can store lists of preprogrammed websites according to themes called theme lists 402 in the account instructions 143 portion of memory 141. The theme lists 402 cater to specific audiences such as children (e.g., ages 7 and under, 7 to 13, 17 and under, etc.), sportsmen, aviation and NASCAR enthusiasts, or other similar audiences. In addition, the theme lists 402 may include subject-type websites such as educational websites, websites with games, news websites, or other websites having similar subjects.

The theme lists 402 also may be sold in a preprogrammed CD format, called theme list CDs 404, that contain catalogs of preprogrammed commercial websites and hyperlinks to the websites. The buyer gives the theme list CD 404 to a shopper who loads the CD into disk drives 113 or 123 of client computers 101 and 102, respectively (see FIG. 4B). The shopper, using the theme list CD 404, may access directly commercial websites, without needing to access the commercial websites through the clearinghouse server computer 104. The lists of approved websites are preprogrammed into the CD, and the CDs direct the commercial websites to request payment from the clearinghouse server computer 104 that debits the balance of the buyer's online account identified by the CD. Account balances for the CDs are set up similarly to the online accounts as explained above, and like the online accounts, the CDs can be programmed to cater to specific audiences, such as children (e.g., 7 and under, 7 to 13, 17 and under, etc.), sportsmen, aviation and NASCAR enthusiasts, or other similar audiences.

Alternatively, the buyer may create a customized list of authorized commercial websites 406 that are programmed into the clearinghouse computer 104 over network 103 from client computers 101 or 102 and stored in the account instructions 143 portion of memory 141 corresponding to the buyer's online account (see FIG. 4A). The buyer customized website list 406 may comprise at least one of approved buyer-defined websites, buyer-selected theme lists 402, and access codes 408. In addition, the buyer may change the customized website list as desired.

The buyer may also program access codes 408 into the online account to exclude access by shoppers to certain categories of websites, such as all X-rated sites. To program the access codes into the online account, the buyer may input examples of words that commercial websites may use as metatags to attract customers to their websites. The words are input to the account instructions 143 portion of memory in the clearinghouse server computer 104 corresponding to the buyer's online account over the network 103 from client computers 101 or 102. Using this method, buyers may exclude access by shoppers to commercial websites that target consumers to shop at or visit their websites.

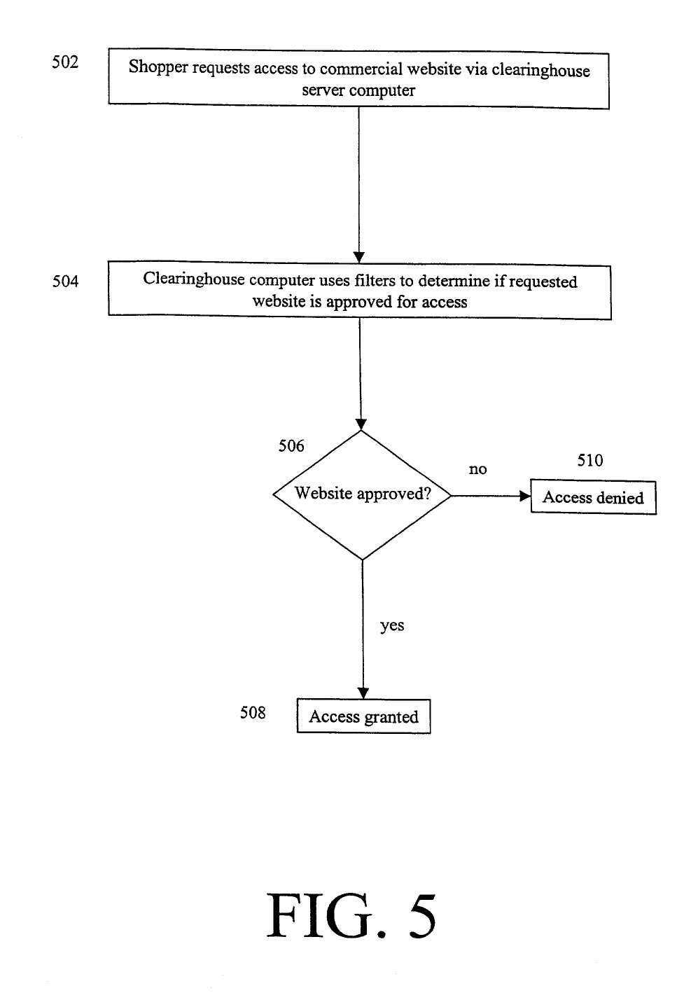

FIG. 5 is a flow chart that illustrates the method of access by shoppers to commercial websites according to the present invention. The shopper requests access to a commercial website via the clearinghouse server computer 104 (502), which protects the shopper's identity from the website. The clearinghouse server computer 104 determines whether the requested website is approved for access (504) by using filters that compare the requested website to the approved or disapproved websites set for the online account. When the clearinghouse server computer 104 grants access to the requested website (506), business transactions may occur between the website, the shopper, and the online account. If access to the requested website is denied by the clearinghouse computer 104 (508), connection to the website is refused and no business transaction may occur.

Several advantages may be gleaned from the foregoing system. First, buyers (e.g., parents) may restrict access of shoppers (e.g., children) to undesirable websites, such as X-rated sites. Second, buyers may control how their money is spent by shoppers on the Internet. Third, the online accounts may be set up for an indefinite period of time, as long as funds are available for the accounts. Fourth, the identities of shoppers need not be revealed to Internet websites when they access or request access to the websites. That is the clearinghouse server computer can actually contact the website and purchases can be made through the clearinghouse server computer. Once services, information, entertainment or other items have been purchased, the shopper can disclose his/her name, address, etc. and have the shipment made directly to him/her. Alternatively, for an extra charge, a physical central location or clearinghouse can receive the items and reship them to the shopper.

It will be apparent to one of ordinary skill in the art that the embodiments as described above may be implemented in many different embodiments of software, firmware, and hardware in the entities illustrated in the figures. The actual software code or specialized control hardware used to implement the present invention is not limited to the present invention. The operation and behavior of the embodiments are described without specific reference to specific software code or specialized hardware components. Thus, a person of ordinary skill in the art would be able to design software and control hardware to implement the embodiments of the present invention based on the description herein.

The foregoing description of the preferred embodiments provides illustration and description of the present invention, but the description is not intended to be exhaustive or to limit the invention to the precise form disclosed. Modifications and variations of the invention consistent with the above teachings are possible and may be acquired from practice of the invention. Accordingly, the appended claims and any equivalents thereof define the scope of the present invention.

The appended claims do not have limitations phrased in the “means” or “step” (for performing a specified function) format permitted by 35 U.S.C. § 112, paragraph six. Accordingly, the appended claims are not to be interpreted under Section 112, paragraph six.

What is claimed:

1. A method comprising:
initializing an online account at a clearinghouse server computer over a network;
setting access restrictions to network sites for the online account;
requesting access to a site through the clearinghouse server computer;
performing one of approving and disapproving access to the requested site by the clearinghouse server computer; and
controlling access to the requested site by the clearinghouse server computer.

2. The method of claim 1, wherein the initializing and the access restriction setting include issuing a prepaid card associated with the online account, the online account having a predetermined initial value, the online account having predetermined access restrictions associated therewith.

3. The method of claim 1, wherein:
the initializing includes issuing a prepaid card associated with the online account, the online account having an initial value; and
the access restriction setting includes associating the access restrictions with the online account after the prepaid card is issued.

4. The method of claim 1, further comprising issuing a prepaid card after initializing the online account, the prepaid card having a password sent by mail and an account number printed thereon.

5. The method of claim 1, further comprising setting an account balance for the online account at the clearinghouse server computer.

6. The method of claim 5, further comprising setting the account balance by using one of a credit card and an electronic funds transfer from a bank account.

7. The method of claim 6, further comprising linking at least one of the credit card and the bank account to the online account.

8. The method of claim 5, further comprising tracking the account balance.

9. The method of claim 1, further comprising performing one of approving and disapproving access to the requested site by using at least one filter in the clearinghouse server computer that compares the requested site to the access restrictions set for the online account.

10. The method of claim 1, further comprising setting the access restrictions by using at least one of a theme list, a theme list CD, a customized site list, and at least one access code.

11. The method of claim 10, further comprising programming at least one of an approved site list, the theme list, and the access code into the customized site list.

12. The method of claim 10, further comprising programming an approved site list into the theme list CD.

13. The method of claim 12, further comprising directing network sites to request payment from the online account by the theme list CD when access to the network sites is approved.

14. The method of claim 10, further comprising programming the at least one access code with a corresponding metatag that attracts customers to network sites.

15. The method of claim 10, further comprising storing the at least one of a theme list, theme list CD, customized site list, and at least one access code in the clearinghouse server computer.

16. The method of claim 1, further comprising maintaining a confidentiality of a requester when access to the requested site is approved.

17. The method of claim 1, further comprising purchasing items at the requested site when access to the requested site is approved.

18. A method comprising:
initializing an online account at a clearinghouse server computer over a network;
setting an account balance for the online account at the clearinghouse server computer;
setting access restrictions to network sites for the online account, the access restrictions being defined by at least one of a theme list, a theme list CD, a customized site list, and an access code;
requesting access to a site through the clearinghouse server computer;
performing one of approving and disapproving access to the requested site by the clearinghouse server computer by using at least one filter; and
controlling access to the site by the clearinghouse server computer.

19. The method of claim 18, wherein the initializing, the account balance settling and the access restriction setting include issuing a prepaid card associated with the online account, the online account having a predetermined initial value, the online account having predetermined access restrictions associated therewith.

20. The method of claim 18, wherein:
the initializing and the account balance setting include issuing a prepaid card associated with the online account, the online account having an initial value; and
the access restriction setting includes associating the access restrictions with the online account after the prepaid card is issued.

21. The method of claim 18, further comprising issuing a prepaid card after initializing the online account, the prepaid card having a password sent by mail and an account number printed thereon.

22. The method of claim 18, further comprising setting the account balance by using one of a credit card and an electronic funds transfer from a bank account.

23. The method of claim 22, further comprising linking at least one of the credit card and the bank account to the online account.

24. The method of claim 18, further comprising tracking the account balance.

25. The method of claim 18, further comprising the at least one filter in the clearinghouse server computer comparing the requested site to the access restrictions set for the online account when performing the one of approving and disapproving access to the requested site.

26. The method of claim 18, further comprising programming at least one of n approved site list, the theme list, and the access code into the customized site list.

27. The method of claim 18, further comprising programming an approved site list into the theme list CD.

28. The method of claim 27, further comprising directing network sites to request payment from the online account by the theme list CD when access to the network sites is approved.

29. The method of claim 18, further comprising programming the at least one access code with a corresponding metatag that attracts customers to network sites.

30. The method of claim 18, further comprising storing the at least one of a theme list, theme list CD, customized site list, and access code in the clearinghouse server computer.

31. The method of claim 18, further comprising maintaining a confidentiality of a requestor when requesting access to the site and when access to the requested site is approved.

32. The method of claim 18, further comprising purchasing items at the requested site when access is approved.

33. A method comprising:
initializing an online account at a clearinghouse server computer over a network;
setting an account balance for the online account at the clearinghouse server computer;
setting access restrictions to network sites for the online account, the access restrictions being defined by a theme list CD;
requesting access directly to a site using the theme list CD;
performing one of approving and disapproving access to the requested site by using the access restrictions in the theme list CD; and
controlling access to the site by the theme list CD.

34. The method of claim 33, further comprising setting the account balance by using one of a credit card and an electronic funds transfer from a bank account.

35. The method of claim 34, further comprising linking at least one of the credit card and the bank account to the online account.

36. The method of claim 33, further comprising tracking the account balance.

37. The method of claim 33, wherein the access restrictions are a preprogrammed list of approved sites programmed into the theme list CD that are compared to the requested site when performing the one of approving and disapproving access to the requested site.

38. The method of claim 33, further comprising directing the requested site to request payment from the online account when purchasing items at the requested site and when access to the requested site is approved.

39. A system comprising:
a network;
one of a plurality of client computers connected to the network;
a clearinghouse server computer connected to the one of a plurality of client computers through the network, the clearinghouse server computer initializing and accessing an online account in the clearinghouse server computer, the online account having an account balance set by the clearinghouse server computer; and
one of a plurality of network server computers connected to the clearinghouse server computer through the network, the one of a plurality of network server computers having at least one network site,
wherein the clearinghouse server computer sets access restrictions to the network sites for the online account,
wherein the one of a plurality of client computers requests access to a site through the clearinghouse server computer, and
wherein the clearinghouse server computer performs one of approving and disapproving access to the requested site and controls access to the requested site.

40. The system of claim 39 further comprising a prepaid card, the prepaid card being associated with the online account, the prepaid card and the online account having an initial predetermined value and the access restrictions associated therewith.

41. The system of claim 39 further comprising a prepaid card, the prepaid card being associated with the online account, the predetermined card and the online account having an initial predetermined value, the clearinghouse server setting the access restrictions after the prepaid card is issued.

42. The system of claim 39, further comprising a prepaid card that is issued after the online account is initialized, the prepaid card having a password sent by mail and an account number printed thereon.

43. The system of claim 39, wherein the account balance is set by using one of a credit card and an electronic funds transfer from a bank account.

44. The system of claim 39, wherein the clearinghouse server computer links at least one of the credit card and the bank account to the online account and tracks the account balance of the online account.

45. The system of claim 39, further comprising at least one of a theme list, a theme list CD, a customized site list, and at least one access code that defines the access restrictions.

46. The system of claim 45, wherein the customized site list comprises at least one of an approved site list, the theme list, and the access code.

47. The system of claim 45, wherein the theme list CD comprises a preprogrammed list of approved sites.

48. The system of claim 47, wherein the theme list CD directs network sites to request payment from the clearinghouse server computer when access to the network sites is approved.

49. The system of claim 45, wherein the at least one access code is programmed with a corresponding metatag that attracts customers to network sites.

50. The system of claim 45, wherein the clearinghouse server computer stores in its memory the at least one of a theme list, the customized list, and the at least one access code.

51. The system of claim 39, further comprising a confidentiality of a requester that is maintained when access to the requested site is approved.

52. The system of claim 39, wherein the clearinghouse server computer comprises at least one filter that is used to perform the one of approving and disapproving access to the requested site by comparing the requested site to the access restrictions set for the online account.

53. The system of claim 39, wherein the clearinghouse server computer controls access to the requested site when purchasing items at the requested site and when access to the requested site is approved.

54. A system comprising:
a network;
one of a plurality of client computers connected to the network;
a clearinghouse server computer connected to the one of a plurality of client computers through the network, the clearinghouse server computer initializing and accessing an online account in the clearinghouse server computer, the online account having an account balance set by the clearinghouse server computer;
one of a plurality of network server computers connected to the clearinghouse server computer through the network, the one of a plurality of network server computers having network sites; and
at least one of a theme list, a theme list CD, a customized site list, and at least one access code stored in the clearinghouse server computer that defines access restrictions to the network sites for the online account,
wherein the one of a plurality of client computers requests access to a site at the one of a plurality of network server computers through the clearinghouse sever computer, and
wherein the clearinghouse server computer performs one of approving and disapproving access to the requested site and controls access to the requested site.

55. The system of claim 54 further comprising a prepaid card, the prepaid card being associated with the online account, the prepaid card and the online account having an initial predetermined value and the access restrictions associated therewith.

56. The system of claim 54 further comprising a prepaid card, the prepaid card being associated with the online account, the predetermined card and the online account having an initial predetermined value, the clearinghouse server setting the access restrictions after the prepaid card is issued.

57. The system of claim 56, further comprising a prepaid card that is issued after the online account is initialized, the prepaid card having a password sent by mail and an account number printed thereon.

58. The system of claim 56, wherein the account balance is set by using one of a credit card and an electronic funds transfer from a bank account.

59. The system of claim 58, wherein the clearinghouse server computer links at least one of the credit card and the bank account to the online account and tracks the account balance of the online account.

60. The system of claim 56, wherein the customized site list comprises at least one of an approved site list, the theme list, and the access code.

61. The system of claim 56, wherein the theme list CD comprises a preprogrammed list of approved sites.

62. The system of claim 61, wherein the theme list CD directs network sites to request payment from the online account when access to the network sites is approved.

63. The system of claim 56, wherein the at least one access code is programmed with a corresponding metatag that attracts customers to network sites.

64. The system of claim 54, further comprising a confidentiality of a requester that is maintained when access to a requested site is approved.

65. The system of claim 54, wherein the clearinghouse server computer comprises at least one filter that is used to perform the one of approving and disapproving access to the requested site by comparing the requested site to the access restrictions set for the online account.

66. The system of claim 54, wherein the clearinghouse server computer controls access to the requested site when purchasing items at the requested site and when access to the requested site is approved.

67. A system comprising:
a network;
one of a plurality of client computers connected to the network;
a clearinghouse server computer connected to the one of a plurality of client computers through the network, the clearinghouse server computer initializing and accessing an online account in the clearinghouse server computer, the online account having an account balance set by the clearinghouse server computer;
one of a plurality of network server computers connected to the clearinghouse server computer through the network, the one of a plurality of network server computers having network sites; and
a theme list CD that defines access restrictions to the network sites for the online account,
wherein the one of a plurality of client computers, using the theme list CD, requests access directly to a site at the one of a plurality of network server computers,
wherein the theme list CD performs one of approving and disapproving access to the requested site by using the access restrictions in the theme list CD, and
wherein the theme list CD controls access to the requested site.

68. The system of claim 67, wherein the account balance is set by using one of a credit card and an electronic funds transfer from a bank account.

69. The system of claim 68, wherein the clearinghouse server computer links at least one of the credit card and the bank account to the online account and tracks the account balance of the online account.

70. The system of claim 67, further comprising the access restrictions being a preprogrammed list of approved sites programmed into the theme list CD, the access restrictions being compared to the requested site when performing the one of approving and disapproving access to the requested site.

71. The system of claim 67, wherein the theme list CD controls access to the requested site by directing the requested site to request payment from the online account when access to the requested site is approved.
